(19) United States
(12) Patent Application Publication
(10) Pub. No.: US 2022/0166281 A1
(43) Pub. Date: May 26, 2022

(54) HYBRID MODULE HAVING AN END SHIELD, AND DRIVE TRAIN

(71) Applicant: Schaeffler Technologies AG & Co. KG, Herzogenaurach (DE)

(72) Inventors: Dominik Weis, Bühl (DE); Dirk Hofstetter, Durmersheim (DE)

(73) Assignee: Schaeffler Technologies AG & Co. KG, Herzogenaurach (DE)

(21) Appl. No.: 17/439,214

(22) PCT Filed: Jan. 9, 2020
(86) PCT No.: PCT/DE2020/100008

§ 371 Date: Sep. 14, 2021

(30) Foreign Application Priority Data
Mar. 15, 2019 (DE) 10 2019 106 623.9

(51) Int. Cl. H02K 5/15; F16D 21/06; H02K 7/00; H02K 7/108; H02K 11/21

(52) U.S. Cl. CPC H02K 5/15; F16D 21/06; F16D 2300/12; H02K 7/108; H02K 11/21; H02K 7/006

(57) ABSTRACT

A hybrid module for a drive train of a motor vehicle, having an input shaft that can be connected to an internal combustion engine, an end shield supporting the input shaft, an electric machine arranged concentrically with respect to the input shaft and axially beside the end shield, and at least one clutch Both, at least one of two clutch components of the at least one clutch that can be uncoupled from one another and also a rotor of the electric machine, are mounted on the end shield so as to be rotatable relative to the latter. A stator of the electric machine is fixed directly to the end shield.

### CROSS-REFERENCE TO RELATED APPLICATIONS

This application is the U.S. National Phase of PCT Appln. No. PCT/DE2020/100008 filed Jan. 9, 2020, which claims priority to DE 102019106623.9 filed Mar. 15, 2019, the entire disclosures of which are incorporated by reference herein.

### TECHNICAL FIELD

The disclosure relates to a hybrid module for a drive train of a motor vehicle, such as a car, truck, bus or other commercial vehicle, having an input shaft that can be connected to an internal combustion engine, an end shield supporting the input shaft, an electric machine arranged concentrically with respect to the input shaft and axially beside the end shield, and at least one clutch, wherein both at least one of two clutch components of the at least one clutch that can be uncoupled from one another and also a rotor of the electric machine are mounted on the end shield so as to be rotatable relative to the latter. The hybrid module is thus typically implemented as a module consisting of at least one clutch and one electric machine. The disclosure also relates to a drive train having said hybrid module.

### BACKGROUND

Generic hybrid modules are already sufficiently known from the prior art. Accordingly, WO 2015/188819 A2, for example, discloses a modular housing for a hybrid module.

Hybrid modules with complete housings are thus already known from the prior art, wherein these housings can also be constructed in several parts. The housings are typically bolted between the internal combustion engine and a transmission. It has been shown, however, that the hybrid modules that have hitherto been fully installed in the usual way, i.e., with the entire housing in one step, cannot be used as a whole in the drive train due to further restricted installation space conditions. This in turn results in a relatively high installation effort on the part of the customer, since the previously fully installed hybrid module may have to be dismantled again in order to install it in the drive train. In addition, there is no unit that can be checked by the customer.

### SUMMARY

It is therefore the object of the present disclosure to eliminate the disadvantages known from the prior art and, in particular, to provide a hybrid module that is prepared as an independent module with regard to its testability and that takes up as little space as possible.

This is achieved according to the disclosure in that a stator of the electric machine is fastened directly to the end shield.

The electric machine is thus completely received on the end shield and forms with it a module that is fully installed before delivery to the end customer and that forms a testable unit.

Further advantageous embodiments are described in the claims and explained in more detail below.

Accordingly, it is also advantageous if the end shield has a disk region extending in the radial direction, wherein the stator is fastened directly to an axial side of this disk region. The disk region is preferably thicker than the further disk region on a region receiving the stator. This results in a particularly robust support of the stator.

Furthermore, it is expedient if the end shield forms a centering shoulder radially outside of a fastening region receiving the stator, onto which centering shoulder a further housing part of a housing can be pushed. This further simplifies the installation of the hybrid module.

If a sealing element is received on the end shield, an interior of the hybrid module is reliably sealed off from the environment in an installed state of a housing of the hybrid module. If the sealing element is an O-ring, it is easy to manufacture and install.

If the sealing element is arranged in a groove made in the centering shoulder, the position of the sealing element is secured when the hybrid module is installed.

The at least one clutch is preferably designed to be wet-running.

In addition, it is advantageous if a fastening tab for connecting to a further housing part is formed on the end shield radially outside the centering shoulder. This further simplifies the installation of the hybrid module in the drive train.

If a rotor position sensor is also attached to the end shield, the end shield is used to receive a plurality of electrical components. This keeps the number of components used as low as possible.

If the rotor position sensor is fastened to the end shield radially inside the fastening region receiving the stator, electric machines and the end shield can be arranged in an axially even more compact manner.

A particularly stable mounting of the rotor is provided if a carrier is provided which receives the rotor in a rotationally fixed manner and is supported on the end shield via at least one bearing, wherein this carrier preferably also receives a first clutch component of the at least one clutch in a rotationally fixed manner or directly forms the same. This keeps the design of the hybrid module particularly simple.

Furthermore, the disclosure relates to a drive train for a motor vehicle, having a hybrid module according to the disclosure according to at least one of the embodiments described above.

In other words, the disclosure consequently relates to a clutch cover (end shield) for hybrid modules. Electrical components are attached to the clutch cover/end shield of the hybrid module to form a testable unit that can be installed as a “plug-in module”. A seal is produced as an O-ring. As a result, the hybrid module can be easily integrated into a transmission.

### BRIEF DESCRIPTION OF THE DRAWINGS

In the following, the disclosure is now explained in more detail with reference to figures.

In the figures:

FIG. 1 shows a longitudinal sectional view of a hybrid module according to the disclosure according to a preferred exemplary embodiment, wherein the hybrid module is further already connected to a further housing part within a drive train and hatching is dispensed with,

FIG. 2 shows a longitudinal sectional view of the hybrid module according to FIG. 1 without the housing part,

FIG. 3 shows a perspective representation of an end shield designed according to the disclosure used in FIGS. 1 and 2, and

FIG. 4 shows a detailed view of FIG. 2 towards a fastening region of the end shield that is fastened to a stator.

The figures are only schematic in nature and serve only for understanding the disclosure. The same elements are provided with the same reference symbols.

### DETAILED DESCRIPTION

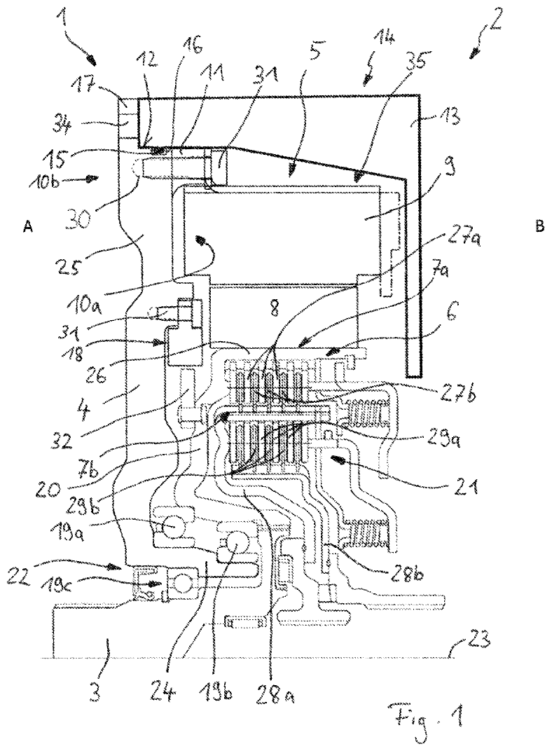

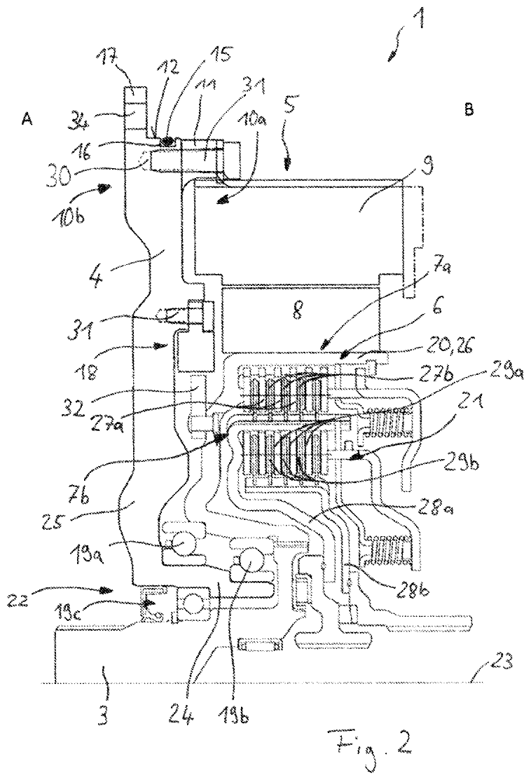

In connection with FIGS. 1 and 2, a hybrid module 1 according to the disclosure according to a preferred exemplary embodiment is illustrated in its entirety. The hybrid module 1 is used in FIG. 1 in a drive train 2 of a motor vehicle, which is indicated in principle. The basic structure of the hybrid module 1 shows that, in addition to an electric machine 5, two clutches 6, 21 are present in this embodiment. The clutches 6, 21 are implemented in a wet-running manner.

In FIG. 1, a housing part 13, which is implemented as a clutch housing, is shown on the part of the drive train 2. During operation, the housing part 13 is further connected to a transmission housing of a transmission, which is not shown here for the sake of clarity. The housing part 13, together with an end shield 4, forms a common housing 14. The hybrid module 1 is used during operation between an internal combustion engine and the transmission. The housing 14 of the hybrid module 1 has an internal combustion engine-facing side/motor side A and a transmission-facing side/transmission side B.

The axial and radial directions used below relate to a central rotational axis 23, about which rotational axis 23, for example, an input shaft 3 of the hybrid module 1, described in more detail below, is rotatably mounted.

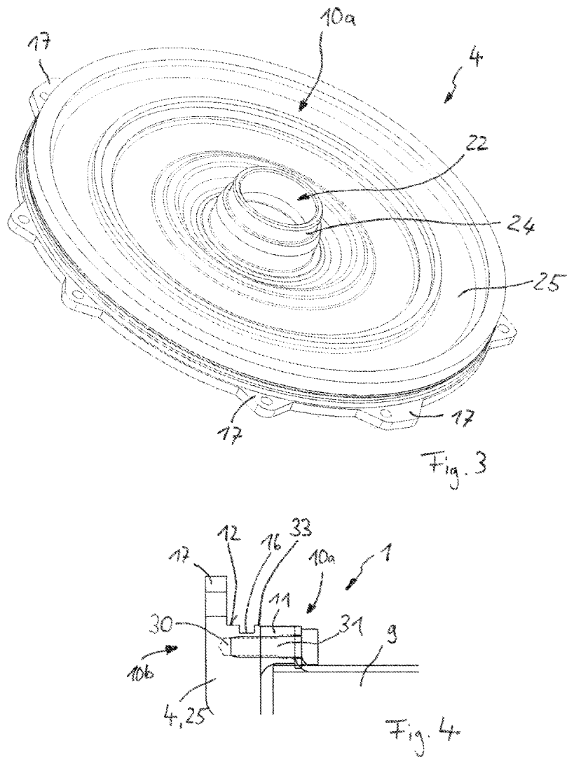

As can also be seen clearly in FIG. 3, the end shield 4 forms a central opening 22 through which an input shaft 3 protrudes. The input shaft 3 protrudes from the motor side A into the housing 14. The input shaft 3 is non-rotatably connected to the motor side A during operation with an output shaft of the internal combustion engine. In an interior 35 of the housing 14, the input shaft 3 is permanently rotatably connected to a central carrier 20. The input shaft 3 and carrier 20 thus rotate about the central rotational axis 23 during operation. The input shaft 3 is supported on a radial inside of the end shield 4 via a (third) bearing 19c. In particular, the end shield 4 forms a bearing journal 24 projecting axially away from the motor side A, on the radial inside of which the third bearing 19c in the form of a rolling bearing, namely a ball bearing, is received. A side of the end shield 4 facing the transmission side B is referred to as the first axial side 10a, and a side of the end shield 4 facing the motor side A is referred to as the second axial side 10b.

Furthermore, the carrier 20 is supported/rotatably mounted by two further bearings 19a and 19b (first bearing 19a and second bearing 19b) on a radial outer side of the bearing journal 24. The carrier 20 is supported directly on the end shield 4/bearing journal 24 via a first bearing 19a and a second bearing 19b which is axially and radially offset relative to the first bearing 19a. The first bearing 19a and the second bearing 19b are each implemented as rolling bearings, namely ball bearings. From the central bearing journal 24, the end shield 4 merges into a disk region 25 extending radially outward. The plate-shaped disk region 25 forms a side wall of the housing 14.

A stator 9 of the electric machine 5 is fixedly received in the housing 14. For this purpose, according to the disclosure, the stator 9 is fastened directly to the end shield 4, namely to the disk region 25. The stator 9 is fastened on an axial side (first axial side 10a) of the disk region 25 facing the transmission side B. A rotor 8 of the electric machine 5 is arranged radially inside the stator 9. The electric machine 5, i.e., the stator 9 and the rotor 8, are arranged to be axially adjacent to the disk region 25. The rotor 8 is rotatably mounted on the end shield 4 by means of the carrier 20. The rotor 8 preferably has a laminated rotor core (not shown here for the sake of clarity) and is directly received/fixed on a radial outer side of a sleeve-shaped receiving region 26 of the carrier 20 extending in the axial direction.

A plurality of, here two, couplings 6, 21 are arranged radially within the receiving region 26. Each clutch 6, 21 is implemented as a multi-plate friction clutch. A first clutch 6 with its friction elements 27a, 27b is arranged radially outside and axially at the same height as a plurality of friction elements 29a, 29b of a second clutch 21. The first clutch 6 with its first clutch component 7a is received directly on the carrier 20. For this purpose, a plurality of first friction elements 27a of the first clutch 6 are received in a rotationally fixed manner and axially displaceably relative to one another on the radial inside of the receiving region 26. The first friction elements 27a together with a radial inside of the receiving region 26 thus form the first clutch component 7a of the first clutch 6. Thus, at least the first clutch component 7a together with the rotor 8 is rotatably supported on the end shield 4 via the common carrier 20 and the bearings 19a and 19b. A second clutch component 7b of the first clutch 6 that can be coupled to the first clutch component 7a has a plurality of second friction elements 27b, which second friction elements 27b are arranged alternately with the first friction elements 27a in the axial direction. The second friction elements 27b are non-rotatably connected to a (first) carrier element 28a of the second clutch component 7b.

The second clutch 21 is implemented similarly to the first clutch 6. A plurality of first friction elements 29a of the second clutch 21 are held non-rotatably and axially displaceably relative to one another on a radial inside of the first carrier element 28a. A plurality of second friction elements 29b of the second clutch 21, which can be coupled to the first friction elements 29a, are received on a second carrier element 28b in a rotationally fixed manner and axially displaceably relative to one another.

With regard to the disk region 25 receiving the stator 9, it can also be seen that a fastening region 11 of the end shield 4 which directly receives the stator 9 is thickened in relation to the further disk region 25. This thickened fastening region 11 has a receiving hole 30 (in the form of a blind hole) for a fastening means, here a screw 31. The screw 31 is screwed into an internal thread of the receiving hole 30. A rotor position sensor 18 is fastened to the end shield 4 radially within the fastening region 11 and radially within the stator 9. Like the stator 9, the rotor position sensor 18 is fastened to the first axial side 10a of the end shield 4. The rotor position sensor 18 is also fastened to the end shield 4 via a screw 31. The rotor position sensor 18 detects a rotational position and/or movement of the rotor 8, for example in the form of a speed. An encoder part 32 which interacts with the rotor position sensor 18 is fastened to the carrier 20.

The end shield 4 also forms a centering shoulder 12 radially outside of the fastening region 11. This centering shoulder 12 is implemented as an axial shoulder. The centering shoulder 12 forms a circumferential support surface which points outward in the radial direction and onto which the housing part 13 is pushed during installation. The centering shoulder 12, as can be seen in more detail in FIG. 4, is directly equipped with a ring-shaped circumferential groove 16. A sealing element 15 in the form of an O-ring is inserted within this groove 16 (FIGS. 1 and 2). As a result, a gap between the end shield 4 and the housing part 13 is sealed in the fully installed position of the hybrid module 1 in the drive train 2. As a result, the interior 35 of the housing 14 is sealed off relative to its surroundings. The centering shoulder 12 is provided with a bevel 33 on the front side so that the housing part 13 can be pushed on more easily.

In turn, radially outside the centering shoulder 12, a fastening tab 17 protruding radially outward adjoins it. The fastening tab 17 is provided with a through-hole 34, which in turn serves to receive a fastening element, such as a screw, in order to firmly connect the housing part 13 to the end shield 4. This fastening tab 17 can also be seen in detail in FIG. 3.

In other words, a clutch cover/end shield 4 is provided according to the disclosure, on which electrical components (stator 9 and rotor position sensor 18) are also fixed. This creates a testable unit which can be installed as a plug-in module 1 at the customer's facility. An O-ring 15 is used for sealing. This means that there are no costs for the customer when integrating the module 1 into the overall transmission.

The module 1 consists of the end shield/clutch cover 4, which supports the starting and separating elements 6, 21. The starting/separating elements 6, 21 are mounted below the EM rotor 8. The electrical components of the EM stator 9 and position sensor stator 18 are fixed on the clutch cover 4. This is preferably achieved using screws 31 in each case. What is termed the wet space (interior 35) on the transmission side B is sealed off from combustion engine side A by a sealing element 15, preferably an O-ring. The module 1 is sealed and centered via a prepared surface 12 on the clutch cover 4 and on the clutch housing (housing part 13). The module 1 is axially fixed by means of screw-on tabs (fastening tabs 17) on the clutch cover 4. The installation with the customer takes place by pushing the module 1 into the coupling housing 13, with subsequent fixing with screws. The hybrid module 1 is thus equipped with wet-running starting/separating elements 6, 21.

### LIST OF REFERENCE NUMBERS

1 Hybrid module
2 Drive train
3 Input shaft
4 End shield
5 Electric machine
6 First clutch
7a First clutch component
7b Second clutch component
8 Rotor
9 Stator
10a First side
10b Second side
11 Fastening region
12 Centering screw
13 Housing part
14 Housing
15 Sealing element
16 Slot
17 Fastening tab
18 Rotor position sensor
19a First bearing
19b Second bearing
19c Third bearing
20 Carrier
21 Second clutch
22 Opening
23 Rotational axis
24 Bearing journal
25 Disk region
26 Receiving region
27a First friction element of the first clutch
27b Second friction element of the first clutch
28a First carrier element
28b Second carrier element
29a First friction element of the second clutch
29b Second friction element of the second clutch
30 Receiving hole
31 Screw
32 Encoder part
33 Bevel
34 Through-hole

1. A hybrid module for a drive train of a motor vehicle, comprising:
an input shaft configured to be connected to an internal combustion engine,
an end shield supporting the input shaft,
an electric machine arranged concentrically with respect to the input shaft and axially beside the end shield, and
at least one clutch, wherein both, at least one of two clutch components of the at least one clutch that can be uncoupled from one another and also a rotor of the electric machine, are mounted on the end shield so as to be rotatable relative to the latter, wherein a stator of the electric machine is fixed directly to the end shield.

2. The hybrid module according to claim 1, wherein the end shield has a disk region extending in a radial direction, wherein the stator is fastened directly to an axial side of the disk region.

3. The hybrid module according to claim 1, wherein the end shield forms a centering shoulder radially outside of a fastening region receiving the stator, onto which the centering shoulder a further housing part of a housing can be pushed.

4. The hybrid module according to claim 3, wherein a sealing element is received on the end shield.

5. The hybrid module according to claim 4, wherein the sealing element is arranged in a groove made in the centering shoulder.

6. The hybrid module according to claim 3, wherein a fastening tab for connecting to the further housing part is formed on the end shield radially outside the centering shoulder.

7. The hybrid module according to claim 3, wherein a rotor position sensor is fastened to the end shield.

8. The hybrid module according to claim 7, wherein the rotor position sensor is fastened to the end shield radially inside the fastening region receiving the stator.

9. The hybrid module according to claim 1, wherein a carrier which receives the rotor in a rotationally fixed manner and is supported on the end shield via at least one bearing receives a first clutch component of the at least one clutch in a rotationally fixed manner or directly forms the same.

10. A drive train for a motor vehicle, having a hybrid module according to claim 1.

11. A hybrid module for a drive train of a motor vehicle, comprising:
an end shield arranged to support an input shaft;
an electric machine arranged axially beside the end shield, the electric machine including a rotor mounted on the end shield and a stator fixed directly to an axial side of the end shield; and
at least one clutch having first and second clutch components that can be uncoupled from one another, wherein the first or second clutch component is mounted on the end shield so as to be rotatable relative to the rotor.

12. The hybrid module according to claim 11, wherein the end shield comprises:
a disk region extending in a radial direction for receiving the stator; and
a fastening region arranged for receiving a fastener fixing the stator to the end shield, wherein the fastening region is thicker than the disk region.

13. The hybrid module according to claim 12, wherein the fastening region includes a hole configured to receive the fastener.

14. The hybrid module according to claim 12, further comprising a rotor position sensor fastened to the end shield radially within the fastening region and radially within the stator.

15. The hybrid module according to claim 12, wherein the end shield forms a centering shoulder radially outside of the fastening region and a housing part is arranged on the centering shoulder.

16. The hybrid module according to claim 15, further comprising a sealing element disposed in a groove formed in the centering should, wherein the sealing element is configured to seal the end shield and the housing part.
